(19) United States
(12) Patent Application Publication
(10) Pub. No.: US 2024/0152427 A1
(43) Pub. Date: May 9, 2024

(54) INFORMATION PROCESSING APPARATUS, INFORMATION PROCESSING METHOD AND PROGRAM

(71) Applicant: Nippon Telegraph and Telephone Corporation, Tokyo (JP)

(72) Inventors: Masaru Sakai, Musashino-shi, Tokyo (JP); Kensuke TAKAHASHI, Musashino-shi, Tokyo (JP)

(21) Appl. No.: 18/274,328

(22) PCT Filed: Feb. 5, 2021
(86) PCT No.: PCT/JP2021/004347

§ 371 Date: Jul. 26, 2023

(51) Int. Cl. G06F 11/14

(52) U.S. Cl. CPC G06F 11/1402; G06F 2201/865

(57) ABSTRACT

A service recovery method formulation device (information processing device) 16 includes a recovery method learning unit (learning unit) 165 that recognizes a pattern of each of pieces of recovery operation content for a plurality of recovery operations for services of an application program, groups the plurality of recovery operations for each pattern of the recovery operation content to form a plurality of recovery operation groups, recognizes a pattern of each of pieces of monitoring content for a plurality of pieces of monitoring data related to the services monitored immediately before and after the plurality of recovery operations are performed, respectively, and groups the plurality of pieces of monitoring data for each pattern of the monitoring content to form a plurality of monitoring data groups.

### TECHNICAL FIELD

The present invention relates to an information processing device, an information processing method, and an information processing program.

### BACKGROUND ART

Techniques for maintaining services provided by application programs are known.

For example, there is a micro-service that provides a service by cooperatively operating predetermined components among a plurality of hierarchized and distributed components in a prescribed order. In the maintenance of the micro-service, a health check is executed for each component, normality or abnormality of each component is monitored on the basis of execution results of the health check, and a recovery operation is executed for an abnormal component returning an unexpected result. In addition to monitoring in units of components, there is also a method of detecting an abnormality after looking down a series of flows of services.

On the other hand, in the recovery operation of the micro-service, various recovery methods are considered because of fluidity such as change of components and resources to be used, and there are various options in the application range of the recovery operation of the components because a plurality of components are hierarchized and distributed. In addition, although the recovery operation should be defined in advance, it is difficult to appropriately define the recovery operation having various options after covering various abnormal patterns. Therefore, it is necessary to accumulate know-how while recovery operations are actually being performed at the time of providing a service, and for knowledge about abnormal patterns and the recovery operations to become mature.

Therefore, there is a technique called chaos engineering in which various failures assumed in an actual service are irregularly generated and recovery operations for the respective failures are continuously performed (NPL 1).

### CITATION LIST

### Non Patent Literature

[NPL 1] “ChaosKube,” [Retrieved on Jan. 20, 2021], Internet <URL: https://github.com/linki/chaoskube>

### SUMMARY OF INVENTION

### Technical Problem

However, even with the chaos engineering technique, the continuous improvement of the recovery operation requires a lot of labor because maintenance persons of an implementation organization need to manually analyze and refine the recovery procedure.

The present invention has been made in view of the above-mentioned circumstances, and an object of the present invention is to provide a technique capable of formalizing state transition from an abnormal state to a normal state by a recovery operation as know-how even without a lot of labor of a maintenance person, and capable of formulating a recovery policy at the time of occurrence of a failure or the like.

### Solution to Problem

An information processing device according to one aspect of the present invention includes a learning unit that recognizes a pattern of each of pieces of recovery operation content for a plurality of recovery operations for services of an application program, groups the plurality of recovery operations for each pattern of the recovery operation content to form a plurality of recovery operation groups, recognizes a pattern of each of pieces of monitoring content for a plurality of pieces of monitoring data related to the services monitored immediately before and after the plurality of recovery operations are performed, respectively, and groups the plurality of pieces of monitoring data for each pattern of the monitoring content to form a plurality of monitoring data groups.

An information processing method according to one aspect of the present invention is an information processing method performed by an information processing device, the information processing method including: a step of recognizing a pattern of each of pieces of recovery operation content for a plurality of recovery operations for services of an application program, and grouping the plurality of recovery operations for each pattern of the recovery operation content to form a plurality of recovery operation groups; and a step of recognizing a pattern of each of pieces of monitoring content for a plurality of pieces of monitoring data related to the services monitored immediately before and after the plurality of recovery operations are performed, respectively, and grouping the plurality of pieces of monitoring data for each pattern of the monitoring content to form a plurality of monitoring data groups.

An information processing program according to one aspect of the present invention causes a computer to function as the information processing device.

### Advantageous Effects of Invention

According to the present invention, it is possible to provide a technique capable of formalizing state transition from an abnormal state to a normal state by a recovery operation as know-how even without a lot of labor of a maintenance person, and capable of formulating a recovery policy at the time of occurrence of a failure or the like.

### BRIEF DESCRIPTION OF DRAWINGS

FIG. 1 is a diagram showing a configuration of a service providing system.

FIG. 2 is a diagram showing a functional block configuration of a service recovery method formulation device.

FIG. 3 is a diagram showing storage processing of recovery action data.

FIG. 4 is a diagram showing a specific example of recovery action data.

FIG. 5 is a diagram showing storage processing of monitoring data.

FIG. 6 is a diagram showing learning processing of monitoring data and recovery action data.

FIG. 7 is a diagram showing a specific example of monitoring data and recovery action data.

FIG. 8 is a diagram showing an example of grouping of monitoring data and recovery action data.

FIG. 9 is a diagram showing a specific example of learning result data.

FIG. 10 is a diagram showing determination processing of a recovery method.

FIG. 11 is a diagram showing a determination example of a recovery method.

FIG. 12 is a diagram showing a display example of a recovery method.

FIG. 13 is a diagram showing hardware functions of a service recovery method formulation device.

### DESCRIPTION OF EMBODIMENTS

Hereinafter, embodiments of the present invention will be described with reference to the drawings. Same parts in the drawings will be designated by the same reference numerals and descriptions thereof will be omitted accordingly.

### SUMMARY OF INVENTION

In the present invention, cases of service failures and recovery operations are continuously accumulated, and when a sufficient number of cases have been accumulated, pattern recognition and grouping is performed for each of the service failures and each of the recovery operations, and the service failures are learned in advance by being associated with each other through the recovery operation. Also, using the learning result, a recovery operation suitable for the generated service failure, that is, a recovery action corresponding to the failure pattern, is presented to a maintenance person.

That is, according to the present invention, a plurality of recovery operations and pieces of monitoring data immediately before and after each recovery operation are respectively pattern-recognized and grouped. Therefore, since it is possible to ascertain normal and abnormal state transitions between grouped monitoring data groups, state transitions from an abnormal state to a normal state by a recovery operation can be formalized as know-how even without a lot of labor of a maintenance person, and a recovery policy can be formulated at the time of occurrence of a failure or the like.

In addition, according to the present invention, monitoring data groups in a plurality of monitoring data groups are learned in association with each other through a recovery operation group based on the fact that immediately-before-monitoring data transitions to immediately-after-monitoring data by a recovery operation. Therefore, state transitions from an abnormal state to a normal state can be clearly formalized as know-how, and a recovery policy can be quickly formulated at the time of occurrence of a failure or the like.

[Configuration of Service Providing System]

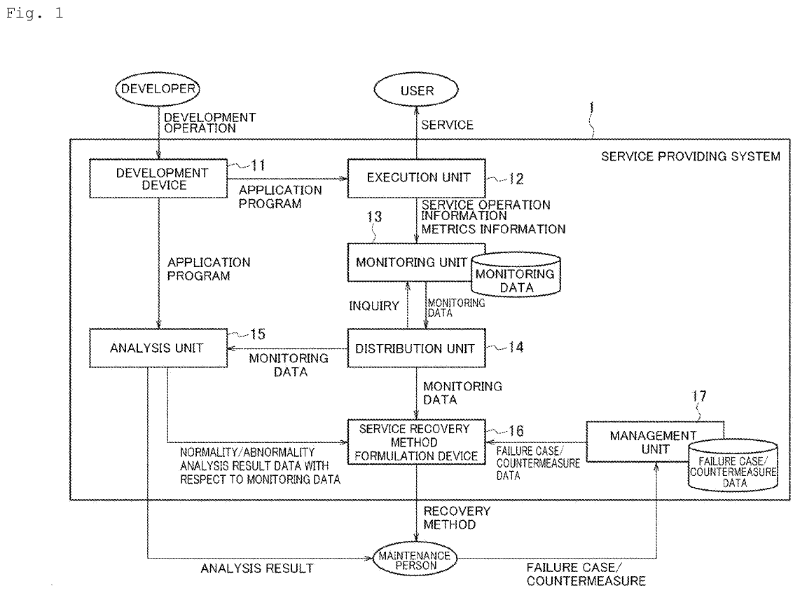

FIG. 1 is a diagram showing a configuration of a service providing system 1. The service providing system 1 includes a development device 11, an execution unit 12, a monitoring unit 13, a distribution unit 14, an analysis unit 15, a service recovery method formulation device 16, and a management unit 17.

The development device 11 is a development environment device for a program developer to perform a development operation of an application program. The development device 11 transmits an application program, some function programs, service update information, and the like created by a program developer to the execution unit 12 and the analysis unit 15.

The execution unit 12 is a functional unit that executes an application program installed in the own unit and provides a service executed by the application program to a user. The service is, for example, a micro-service that provides a service by cooperatively operating predetermined components among a plurality of hierarchized and distributed components in a prescribed order.

The monitoring unit 13 is a functional unit that performs application monitoring to periodically monitor the operation of the application program being executed by the execution unit 12, and stores service operation information of the application program obtained by the application monitoring as monitoring data.

In addition, the monitoring unit 13 is a functional unit that performs resource monitoring to periodically monitor the resources (physical server, virtual server, container, host, CPU, disk, memory, and the like) of the execution unit 12, and stores resource metrics information (usage rate of CPU or memory, or the like) obtained by the resource monitoring as monitoring data.

The distribution unit 14 is a functional unit that acquires monitoring data from the monitoring unit 13 and transmits the monitoring data to the analysis unit 15 and the service recovery method formulation device 16.

The analysis unit 15 is a functional unit that analyzes whether the monitoring data transmitted from the distribution unit 14 is normal or abnormal by an existing method using a function program, service update information, or the like transmitted from the development device 11, and transmits normality or abnormality analysis result data for the monitoring data to the service recovery method formulation device 16 and the maintenance person.

The service recovery method formulation device (information processing device) 16 is a device that learns monitoring data transmitted from the distribution unit 14 and the analysis unit 15 and normality or abnormality analysis result data for the monitoring data in association with past failure case/countermeasure data performed on abnormality monitoring data acquired from the management unit 17.

The service recovery method formulation device 16 is a device that presents a recovery method corresponding to a service failure that will occur in the future to a maintenance person by using the learned learning result data.

The management unit 17 is a functional unit that stores, as failure case/countermeasure data, a recovery operation at the time of occurrence of a service failure input by a maintenance person and respective time stamps of operation start and operation completion of the recovery operation.

[Function of Service Recovery Method Formulation Device]

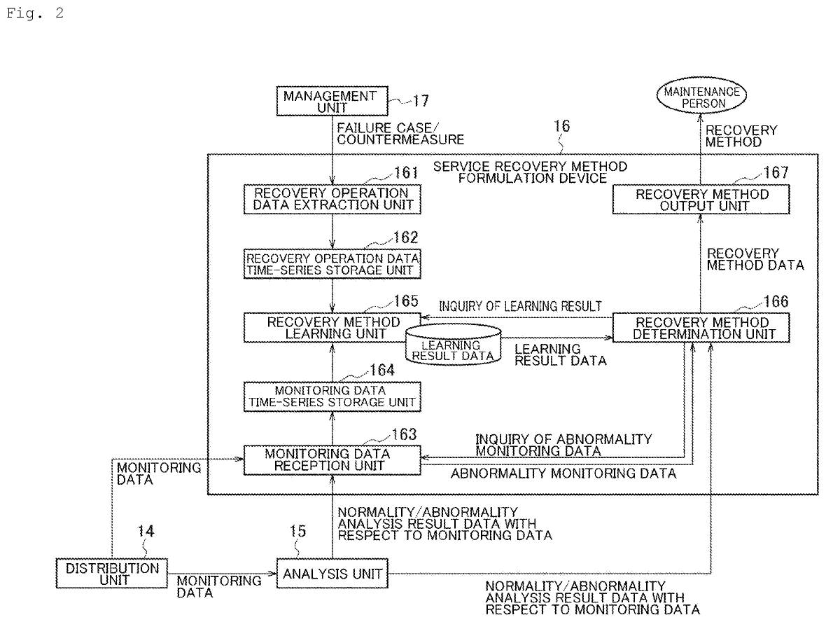

FIG. 2 is a diagram showing a functional block configuration of the service recovery method formulation device 16. The service recovery method formulation device 16 includes a recovery operation data extraction unit 161, a recovery operation data time-series storage unit 162, a monitoring data reception unit 163, a monitoring data time-series storage unit 164, a recovery method learning unit 165, a recovery method determination unit 166, and a recovery method output unit 167.

The recovery operation data extraction unit 161 is a functional unit that acquires failure case/countermeasure data from the management unit 17 and extracts an expression characterizing the content of a recovery operation (hereinafter referred to as a recovery action) from the failure case/countermeasure data.

The recovery operation data time-series storage unit 162 is a functional unit that stores a plurality of pieces of recovery action data in time series on the basis of respective time stamps of operation start and operation completion of the recovery operation.

The monitoring data reception unit 163 is a functional unit that receives monitoring data from the distribution unit 14 and receives a normality or abnormality analysis result for the monitoring data from the analysis unit 15.

The monitoring data time-series storage unit 164 is a functional unit that stores a plurality of pieces of monitoring data in time series on the basis of a time stamp of the monitoring data.

The recovery method learning unit (learning unit) 165 is a functional unit that acquires a plurality of pieces of recovery action data from the recovery operation data time-series storage unit 162 when a sufficient amount of recovery action data and monitoring data have been accumulated, acquires a plurality of pieces of monitoring data from the monitoring data time-series storage unit 164, learns the plurality of pieces of monitoring data and the plurality of pieces of recovery action data in association with each other, and stores the learned learning result data.

Specifically, the recovery method learning unit 165 has a function of recognizing a pattern of each recovery action content for a plurality of recovery actions for services of an application program, grouping the plurality of recovery actions for each pattern of the recovery action content to form a plurality of recovery action groups, recognizing a pattern of each of pieces of monitoring content for a plurality of pieces of monitoring data related to the services monitored immediately before and after the plurality of recovery actions are performed, respectively, and grouping the plurality of pieces of monitoring data for each pattern of the monitoring content to form a plurality of monitoring data groups.

The recovery method learning unit 165 has a function of generating and storing learning result data in which monitoring data groups in the plurality of monitoring data groups are associated with each other through the recovery action group so that immediately-before-monitoring data transitions to immediately-after-monitoring data by a recovery action.

The recovery method determination unit (determination unit) 166 is a functional unit that receives a normality or abnormality analysis result for the monitoring data from the analysis unit 15, acquires abnormality monitoring data in which the analysis result is abnormal from the monitoring data reception unit 163, and determines recovery action data corresponding to a service failure related to the abnormality monitoring data as a recovery method by using learning result data of the recovery method learning unit 165.

Specifically, the recovery method determination unit 166 has a function of searching for a monitoring data group matching abnormality monitoring data analyzed to be in an abnormal state from the learning result data for the abnormality monitoring data, searching for one or more routes transitioning from the determined monitoring data group to a monitoring data group in which pieces of normality monitoring data are grouped, and determining a recovery action of a recovery action group on the selected route as a recovery method.

The recovery method output unit 167 is a functional unit that outputs the recovery method determined by the recovery method determination unit 166 to a display, a printer, or the like of a terminal device provided in a maintenance person.

[Operation of Service Providing System]

[Storage Processing of Recovery Action Data]

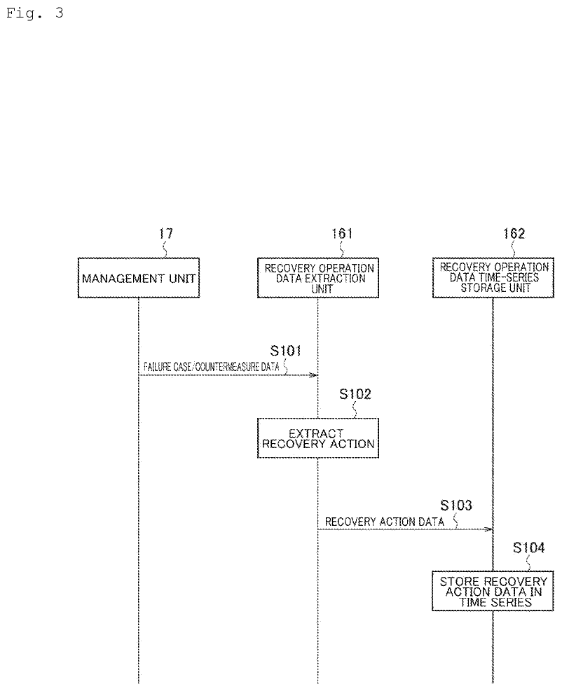

FIG. 3 is a diagram showing storage processing of recovery action data.

Step S101;

First, the recovery operation data extraction unit 161 acquires failure case/countermeasure data from the management unit 17.

Step S102;

Next, the recovery operation data extraction unit 161 extracts recovery action data characterizing the content of a recovery operation from the acquired failure case/countermeasure data. Since it is considered that the failure case/countermeasure data stored in the management unit 17 is input in various formats, in this step, only the required recovery action data is extracted by absorbing differences in format between the failure case/countermeasure data.

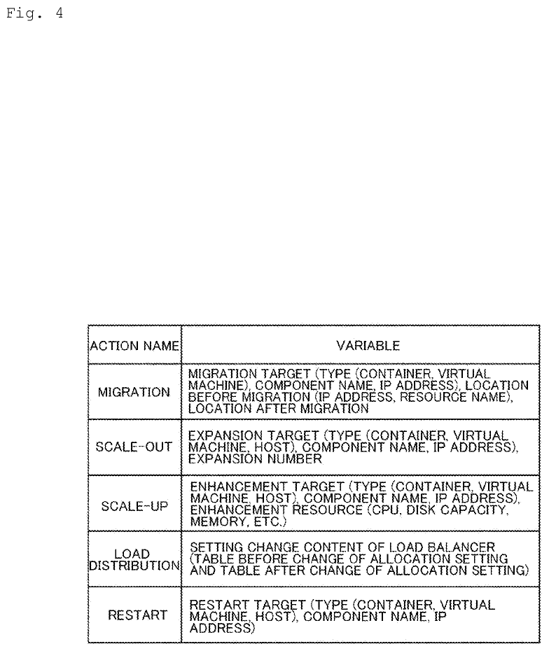

Examples of the recovery action data include an action name indicating the type of recovery action and a variable indicating the target of the recovery action. FIG. 4 shows a specific example of recovery action data. Examples of the action name include (1) migration indicating movement of a container or a virtual machine to another host, (2) scale-out indicating expansion of a container, a virtual machine, a host, or the like, (3) scale-up indicating enhancement of a performance of a container, a virtual machine, a host, or the like, (4) load distribution indicating allocation of processing from an overloaded container, virtual machine, or host to a less loaded one, and (5) restart indicating restarting of a container, a virtual machine, a host, or the like. For example, when the action name is movement, the variables are migration target (type (container, virtual machine), component name, IP address), location before migration (IP address, resource name), and location after migration. The variables related to other action names are as shown in FIG. 4.

Step S103;

Next, the recovery operation data extraction unit 161 transfers the extracted recovery action data (action name, variable) to the recovery operation data time-series storage unit 162.

Step S104;

Finally, the recovery operation data time-series storage unit 162 stores the transferred recovery action data together with the operation time in time series on the basis of each time stamp of operation start and operation completion of the recovery action of the recovery action data.

By repeatedly executing the above processing, a plurality of pieces of recovery action data (action name, variable, operation time) are stored in time series in the recovery operation data time-series storage unit 162.

[Storage Processing of Monitoring Data]

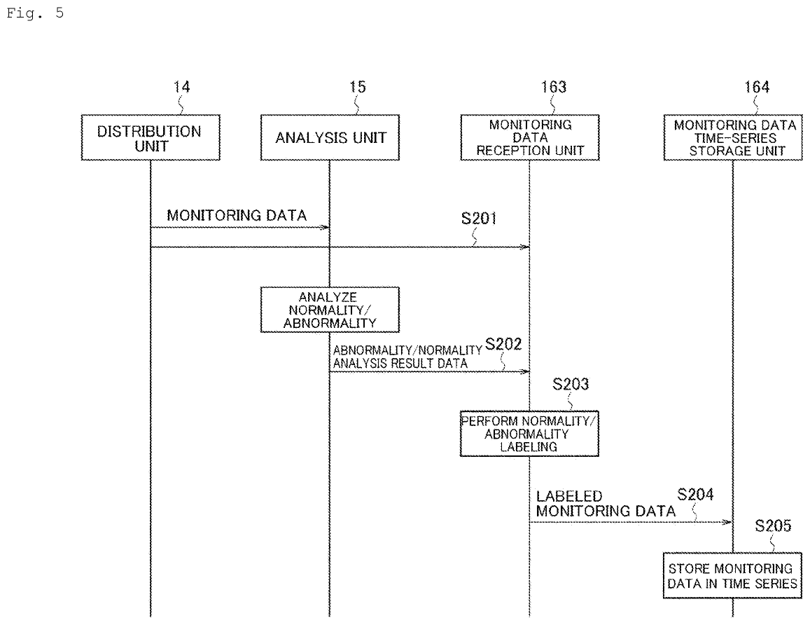

FIG. 5 is a diagram showing storage processing of monitoring data.

Step S201;

First, the monitoring data reception unit 163 receives monitoring data (service operation information, metrics information) from the distribution unit 14.

Step S202;

Next, the monitoring data reception unit 163 receives a normality or abnormality analysis result for the monitoring data from the analysis unit 15.

Step S203;

Next, the monitoring data reception unit 163 adds normal or abnormal labeling information to the monitoring data received from the distribution unit 14 on the basis of the received normality or abnormality analysis result.

Step S204;

Next, the monitoring data reception unit 163 transfers the monitoring data to which the normal or abnormal labeling information is added to the monitoring data time-series storage unit 164.

Step S205;

Finally, the monitoring data time-series storage unit 164 stores the transferred monitoring data in time series on the basis of the time stamp of the monitoring data.

By repeatedly executing the above processing, a plurality of pieces of monitoring data (service operation information, metrics information, normal or abnormal labeling information) are stored in time series in the monitoring data time-series storage unit 164.

[Learning Processing of Monitoring Data and Recovery Action Data]

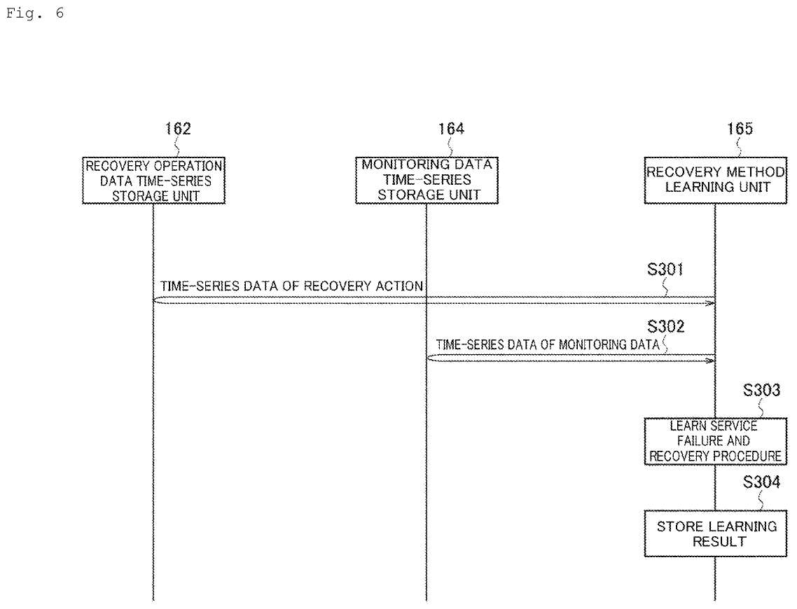

FIG. 6 is a diagram showing learning processing of monitoring data and recovery action data. The recovery method learning unit 165 executes the following processing after a sufficient amount of the recovery action data and the monitoring data have been accumulated.

Step S301;

First, the recovery method learning unit 165 acquires time-series data of a plurality of pieces of recovery action data (action name, variable, and operation time) from the recovery operation data time-series storage unit 162.

Step S302;

Next, the recovery method learning unit 165 acquires time-series data of a plurality of pieces of monitoring data (service operation information, metrics information, normal or abnormal labeling information) from the monitoring data time-series storage unit 164.

Step S303;

Next, the recovery method learning unit 165 learns the plurality of pieces of monitoring data and the plurality of pieces of recovery action data in association with each other by using the acquired time-series data of the plurality of pieces of recovery action data and the acquired time-series data of the plurality of pieces of monitoring data. A learning method will be described below.

First, the recovery method learning unit 165 stores recovery action data, monitoring data immediately before the recovery action of the recovery action data occurs, and monitoring data immediately after the recovery action of the recovery action data is completed as a “result” of the recovery action data.

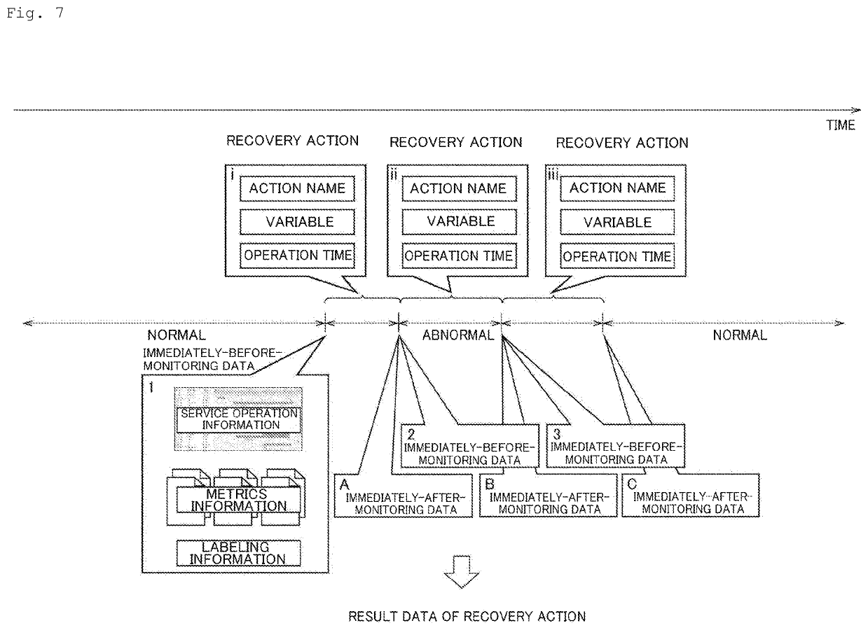

For example, as shown in FIG. 7, when “recovery action of i” is performed on “immediately-before-monitoring data of 1” and “immediately-after-monitoring data of A” is obtained, the “immediately-before-monitoring data of 1,” the “recovery action of i,” and the “immediately-after-monitoring data of A” are associated with each other and stored as “result data.” By continuously performing a maintenance exercise for the failure by using the chaos engineering tool disclosed in NPL 1, “result data” for countless recovery actions is accumulated.

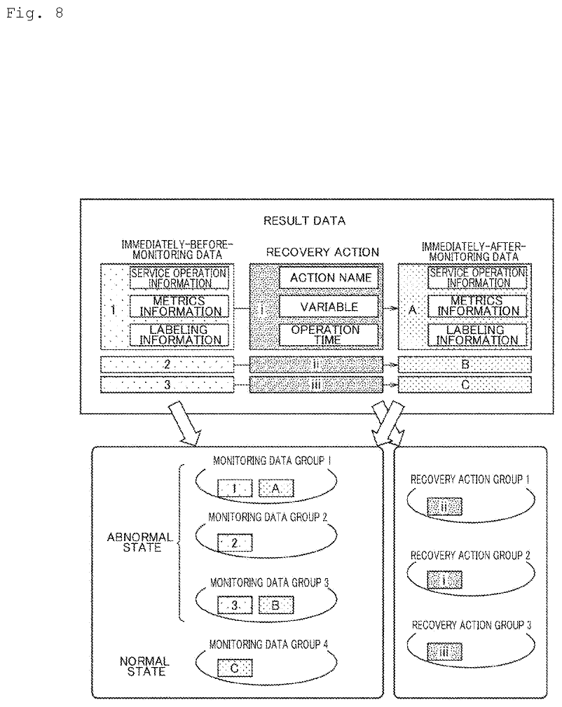

Next, after a sufficient amount of “result data” has been accumulated, the recovery method learning unit 165 performs pattern recognition for ascertaining a recovery action pattern (migration, scale-out, and scale-up, load distribution, restart, and the like) of each recovery action included in each of the plurality of pieces of recovery action data, and performs grouping for classifying the plurality of pieces of recovery action data for each recovery action pattern. FIG. 8 shows a specific example of grouping.

Similarly, the recovery method learning unit 165 performs pattern recognition for ascertaining a monitoring data pattern (content of service operation information, content of metrics information (usage rate of CPU or the like), normal or abnormal labeling information or the like) of each piece of monitoring data included in each of the plurality of pieces of monitoring data (including both immediately-before-monitoring data and immediately-after-monitoring data), and performs grouping for classifying the plurality of pieces of monitoring data for each monitoring data pattern.

In the grouping, a general clustering method or the like is used in accordance with the format of the recovery action data and the monitoring data.

Since it is considered that immediately-before-monitoring data transitions to immediately-after-monitoring data by the recovery action, the recovery method learning unit 165 ascertains a transition relationship from the immediately-before-monitoring data to the immediately-after-monitoring data by the recovery action from the “result data,” and connects the grouped monitoring data groups with an arrow line on the basis of the transition relationship for each grouped monitoring data group so that the transition source and transition destination can be ascertained.

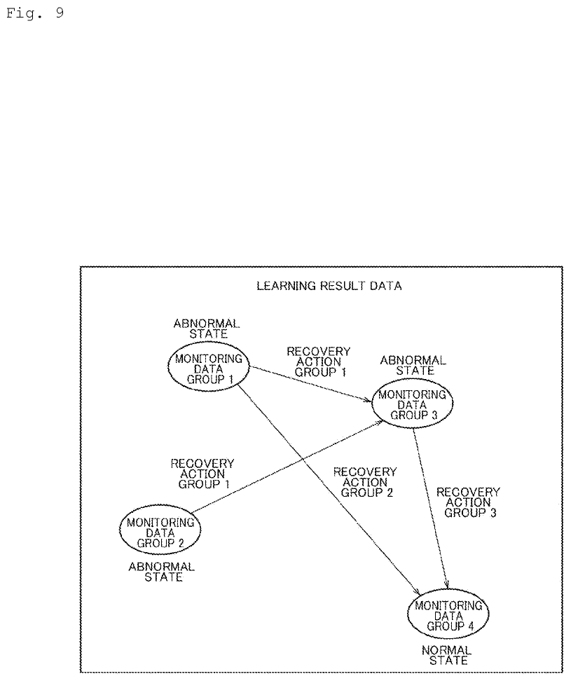

For example, as shown in FIG. 9, the monitoring data included in the monitoring data group 1 is transitioned to the monitoring data included in the monitoring data group 4 through the recovery action group 2. As a result, a directed graph is generated in which the “recovery action group” is used as a transition arc and the “monitoring data group” is used as a node.

Step S304;

Finally, the recovery method learning unit 165 stores the generated directed graph as learning result data. The learning result data is used when determining a recovery method for a service failure that will occur in the future.

[Determination Processing of Recovery Method]

Next, a method of determining a recovery method for a service failure that will occur in the future will be described.

First, the property of the learning result data will be described. The learning result data is obtained by generalizing result know-how for determining a recovery method corresponding to a service failure that will occur in the future as a directed graph. The determination of the recovery method (that is, the determination of the route) is a problem of searching for the route from the monitoring data group in the abnormal state to the monitoring data group in the normal state. The transition arc forming the route is always associated with the recovery action group, and the operation time of the recovery action included in the recovery action group, the total number of the recovery action groups, and the like are defined as costs (weight), and the cost of the entire route is calculated by using the costs.

For example, the result know-how G is assumed to be (V, E). V is a node and is a set of monitoring data groups u. E is a transition arc. The transition arc E always has a recovery action group. The cost of the recovery action group is expressed by giving a weight w such as an operation time to the transition arc E. A recovery method is determined by searching for a route from a monitoring data group u₁∈V as a starting point to a monitoring data group u₂∈V in a normal state, and the weights w of all transition arcs E forming the found route are summed to evaluate the cost of the entire route. Determination processing of the recovery method will be described below.

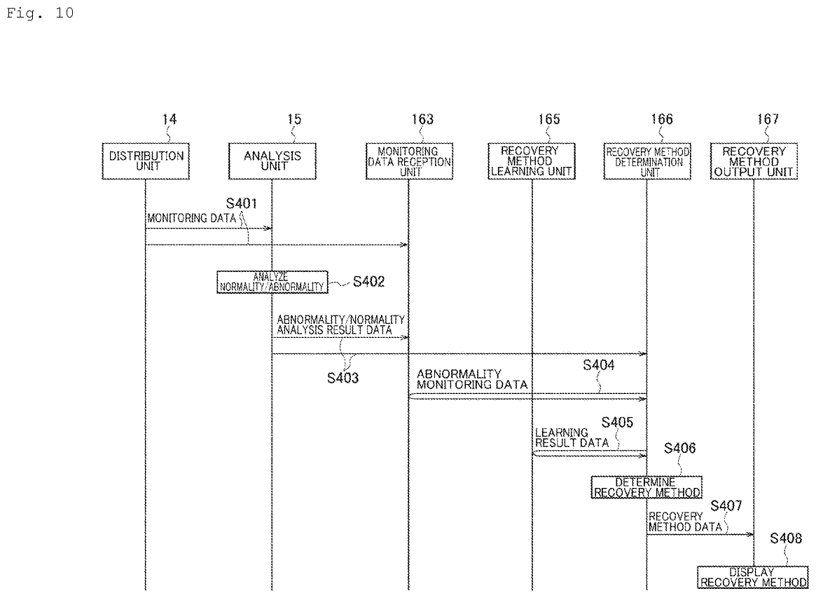

FIG. 10 is a diagram showing determination processing of the recovery method.

Step S401;

First, the distribution unit 14 transmits the monitoring data acquired from the monitoring unit 13 to the analysis unit 15 and the monitoring data reception unit 163.

Step S402;

Next, the analysis unit 15 analyzes whether the transmitted monitoring data is normal or abnormal.

Step S403;

Next, the analysis unit 15 transmits the analyzed normality or abnormality analysis result data to the monitoring data reception unit 163 and the recovery method determination unit 166. Thereafter, the monitoring data reception unit 163 stores monitoring data to which normal or abnormal labeling information is added in the monitoring data time-series storage unit 164, and the recovery method learning unit 165 generates (updates) learning result data by using the monitoring data and a past recovery action to the monitoring data. The method of generating the learning result data is as already described.

Step S404;

Next, the recovery method determination unit 166 acquires abnormality monitoring data having an abnormality analysis result from the transmitted normality or abnormality analysis result data from the monitoring data reception unit 163.

Step S405;

Next, the recovery method determination unit 166 acquires learning result data from the recovery method learning unit 165.

Step S406;

Next, the recovery method determination unit 166 determines a recovery operation corresponding to a service failure related to the acquired abnormality monitoring data as a recovery method by using the acquired learning result data. A method of determining the recovery method will be described below.

In this step, when a service failure occurs, a recovery action considered to be appropriate for recovering the service failure is determined. That is, learning result data generated in advance is collated with monitoring data at the time of occurrence of a service failure, costs on a route are evaluated, and then a plan of a recovery action is derived.

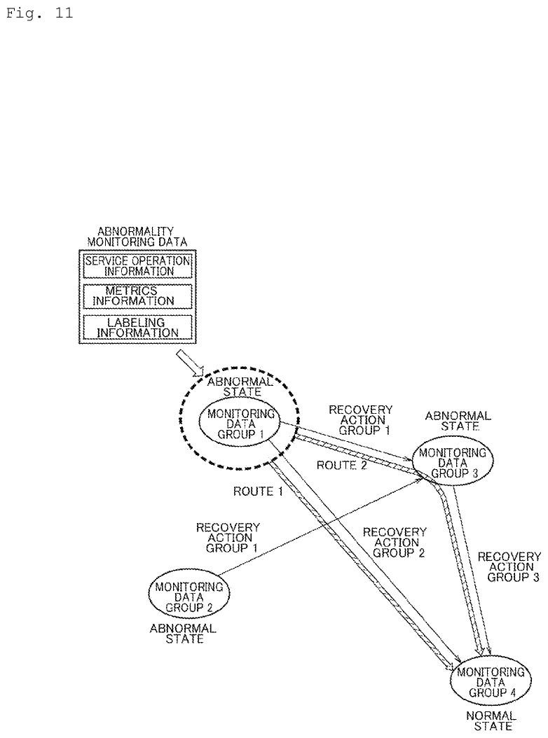

First, the recovery method determination unit 166 performs pattern recognition for ascertaining a monitoring data pattern included in the acquired abnormality monitoring data, and searches to which monitoring data group the abnormality monitoring data best applies among the plurality of monitoring data groups in the learning result data. In the example shown in FIG. 11, the monitoring data group 1 is found as the monitoring data group most similar to the abnormality monitoring data.

Next, the recovery method determination unit 166 searches for all routes from the found monitoring data group to the monitoring data group in the normal state. In the example shown in FIG. 11, two routes, namely, a route 1 passing through the circuit action group 2 and a route 2 passing through the recovery action group 1 and the recovery action group 3, are found as routes from the monitoring data group 1 in the abnormal state to the monitoring data group 4 in the normal state.

Then, the recovery method determination unit 166 sorts all the found routes in ascending order of the cost (operation time) and determines the sorted routes as a recovery method. For example, when the operation time of the recovery action included in the recovery action group 2 of the route 1 is 30 minutes and the total operation time of the recovery actions included in the recovery action group 1 and the recovery action group 3 of the route 2 is 35 minutes, the route 1 and the route 2 are sorted in the order. One route serves as one recovery method. In addition, all recovery action groups included in one route serve as recovery procedures.

Step S407;

Next, the recovery method determination unit 166 transfers recovery method data including all the found recovery methods (one or more routes) to the recovery method output unit 167.

Step S408;

Finally, the recovery method output unit 167 displays the recovery methods included in the transferred recovery method data together with the recovery procedures on the display of the terminal device provided in the maintenance person in ascending order of the cost (operation time) from above.

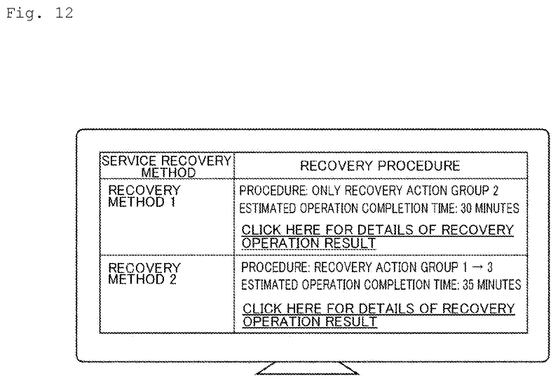

For example, as shown in FIG. 12, the route 1 shown in FIG. 11 is set to the first recovery method, and “only the recovery action of the recovery action group 2” is displayed as a recovery procedure together with estimated operation completion time and a link destination to details of the recovery operation result. The route 2 whose cost is higher than that of the route 1 is set to the second recovery method, and “the recovery action of the recovery action group 1→the recovery action of the recovery action group 3” is displayed as a recovery procedure. The estimated operation completion time is, for example, an average time of operation times of all the recovery actions included in the recovery action group. The information of the link destination to the details of the recovery operation result is set to the past recovery operation corresponding to the recovery action.

### Modification Example

In step S406, the operation time is used as a cost, and the display order of each recovery method is determined based on the magnitude of the operation time. In addition to the operation time, the total number of recovery action groups on the route may be used as a cost, and the display order may be determined based on the total number of recovery action groups. In the example shown in FIG. 11, since the total number of recovery action groups of the route 1 is one and the total number of recovery action groups of the route 2 is two, the route 1 and the route 2 are displayed in the order from above.

### Effects

According to the present embodiment, the recovery method learning unit 165 recognizes a pattern of each recovery action content for a plurality of recovery actions for services of an application program, groups the plurality of recovery actions for each pattern of the recovery action content to form a plurality of recovery action groups, recognizes a pattern of each of pieces of monitoring content for a plurality of pieces of monitoring data related to the services monitored immediately before and after the plurality of recovery actions are performed, respectively, and groups the plurality of pieces of monitoring data for each pattern of the monitoring content to form a plurality of monitoring data groups. Therefore, since it is possible to ascertain normal and abnormal state transitions between grouped monitoring data groups, state transitions from an abnormal state to a normal state by a recovery operation can be formalized as know-how even without a lot of labor of a maintenance person, and a recovery policy can be formulated at the time of occurrence of a failure or the like.

Further, according to the present embodiment, the recovery method learning unit 165 generates learning result data in which monitoring data groups in a plurality of monitoring data groups are associated with each other through a recovery action group so that immediately-before-monitoring data transitions to immediately-after-monitoring data by a recovery action. Therefore, state transitions from an abnormal state to a normal state can be clearly formalized as know-how, and a recovery policy can be quickly formulated at the time of occurrence of a failure or the like.

[Others]

The present invention is not limited to the embodiment described above. The present invention can be modified in a number of ways within the scope of the gist of the present invention.

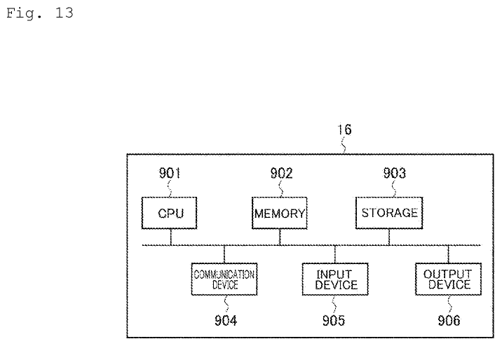

The service recovery method formulation device 16 of the present embodiment described above can be realized by using a general-purpose computer system including a CPU 901, a memory 902, a storage 903, a communication device 904, an input device 905, and an output device 906, for example, as shown in FIG. 13. The memory 902 and the storage 903 are storage devices. In the computer system, the CPU 901 executes a predetermined program loaded on the memory 902 to realize each function of the service recovery method formulation device 16.

The service recovery method formulation device 16 may be implemented using one computer. The service recovery method formulation device 16 may be implemented using a plurality of computers. The service recovery method formulation device 16 may be a virtual machine implemented in a computer. Further, a program for the service recovery method formulation device 16 can be stored in a computer-readable recording medium such as an HDD, an SSD, a USB memory, a CD, and a DVD. The program for the service recovery method formulation device 16 can also be distributed via a communication network.

### REFERENCE SIGNS LIST

1: Service providing system
11: Development device
12: Execution unit
13: Monitoring unit
14: Distribution unit
15: Analysis unit
16: Service recovery method formulation device
17: Management unit
161: Recovery operation data extraction unit
162: Recovery operation data time-series storage unit
163: Monitoring data reception unit
164: Monitoring data time-series storage unit
165: Recovery method learning unit
166: Recovery method determination unit
167: Recovery method output unit
901: CPU
902: Memory
903: Storage
904: Communication device
905: Input device
906: Output device

1. An information processing device comprising one or more processors configured to:
recognize a pattern of each of pieces of recovery operation content for a plurality of recovery operations for services of an application program,
group the plurality of recovery operations for each pattern of the recovery operation content to form a plurality of recovery operation groups,
recognize a pattern of each of pieces of monitoring content for a plurality of pieces of monitoring data related to the services monitored immediately before and after the plurality of recovery operations are performed, respectively, and
group the plurality of pieces of monitoring data for each pattern of the monitoring content to form a plurality of monitoring data groups.

2. The information processing device according to claim 1, wherein the one or more processors are configured to generate learning result data in which monitoring data groups in the plurality of monitoring data groups are associated with each other through the recovery operation group so that immediately-before-monitoring data transitions to immediately-after-monitoring data by a recovery operation.

3. The information processing device according to claim 2, wherein the one or more processors are further configured to:
determine a monitoring data group matching abnormality monitoring data analyzed to be in an abnormal state from the learning result data for the abnormality monitoring data,
search for one or more routes transitioning from the determined monitoring data group to a monitoring data group in which pieces of normality monitoring data are grouped, and
determine a recovery action of a recovery action group on the selected route as a recovery method.

4. An information processing method performed by an information processing device, the information processing method comprising:
recognizing a pattern of each of pieces of recovery operation content for a plurality of recovery operations for services of an application program;
grouping the plurality of recovery operations for each pattern of the recovery operation content to form a plurality of recovery operation groups;
recognizing a pattern of each of pieces of monitoring content for a plurality of pieces of monitoring data related to the services monitored immediately before and after the plurality of recovery operations are performed, respectively; and
grouping the plurality of pieces of monitoring data for each pattern of the monitoring content to form a plurality of monitoring data groups.

5. One or more non-transitory computer-readable media comprising instructions stored thereon that are executable by one or more processing devices and upon such execution cause the one or more processing devices to perform operations comprising:
recognizing a pattern of each of pieces of recovery operation content for a plurality of recovery operations for services of an application program;
grouping the plurality of recovery operations for each pattern of the recovery operation content to form a plurality of recovery operation groups;
recognizing a pattern of each of pieces of monitoring content for a plurality of pieces of monitoring data related to the services monitored immediately before and after the plurality of recovery operations are performed, respectively; and
grouping the plurality of pieces of monitoring data for each pattern of the monitoring content to form a plurality of monitoring data groups.

6. The information processing method according to claim 4, further comprising:
generating learning result data in which monitoring data groups in the plurality of monitoring data groups are associated with each other through the recovery operation group so that immediately-before-monitoring data transitions to immediately-after-monitoring data by a recovery operation.

7. The information processing method according to claim 6, further comprising:
determining a monitoring data group matching abnormality monitoring data analyzed to be in an abnormal state from the learning result data for the abnormality monitoring data;
searching for one or more routes transitioning from the determined monitoring data group to a monitoring data group in which pieces of normality monitoring data are grouped; and
determining a recovery action of a recovery action group on the selected route as a recovery method.

8. The non-transitory computer-readable media of claim 5, further comprising:
generating learning result data in which monitoring data groups in the plurality of monitoring data groups are associated with each other through the recovery operation group so that immediately-before-monitoring data transitions to immediately-after-monitoring data by a recovery operation.

9. The non-transitory computer-readable media of claim 8, further comprising:
determining a monitoring data group matching abnormality monitoring data analyzed to be in an abnormal state from the learning result data for the abnormality monitoring data;
searching for one or more routes transitioning from the determined monitoring data group to a monitoring data group in which pieces of normality monitoring data are grouped; and
determining a recovery action of a recovery action group on the selected route as a recovery method.
